(19) United States
(12) Patent Application Publication
(10) Pub. No.: US 2013/0159561 A1
(43) Pub. Date: Jun. 20, 2013

(54) SYSTEM AND METHOD FOR MONITORING HARD DISK DRIVES

(71) Applicants: Hong Fu Jin Precision Industry (ShenZhen) Co.,, Shenzhen (TW); Hon Hai Precision Industry Co., Ltd., New Taipei (TW)

(72) Inventor: WEI-DONG CONG, Shenzhen (CN)

(73) Assignees: Hon Hai Precision Industry Co., Ltd., New Taipei (TW); Hong Fu Jin Precision Industry (ShenZhen) Co., Ltd, Shenzhen (TW)

(21) Appl. No.: 13/720,587

(22) Filed: Dec. 19, 2012

(30) Foreign Application Priority Data
Dec. 20, 2011 (CN) 201110429629.4

(51) Int. Cl. G06F 3/06

(52) U.S. Cl. CPC G06F 3/0653
USPC 710/19

(57) ABSTRACT

A system remotely monitors a number of hard disk drives (HDDs) in groups in a server. The system includes a data-obtaining unit, a protocol-analyzing unit, a storage unit, a determination unit, and an encoding and delivering unit. The data-obtaining unit obtains a status message of each HDD in a group and forms a message package including all the status messages for the HDDs of one group. The protocol-analyzing unit decodes the message package to generate a number of status codes and obtain the count of the counter. The determination unit obtains the appropriate warning message from the storage unit according to the status code and a current group number. The encoding and delivering unit delivers the warning message and the current group number.

### BACKGROUND

1. Technical Field

The present disclosure relates to a system and method for monitoring hard disk drives.

2. Description of Related Art

A light-emitting diode (LED) of a hard disk drive (HDD) indicates whether or not the HDD is normal. If the HDD operates normally, the LED emits light. If the HDD is abnormal, the LED does not emit light. Thus, it is critical to know whether the LED emits light or not. However, a data center, for example, may comprise hundreds or thousands of HDDs, and it is inefficient and time-consuming for the user to manually check whether all the LEDs are emitting light or not.

Therefore, there is room for improvement in the art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic diagram of a system for monitoring hard disk drives.

FIG. 2 is a block diagram of an embodiment of a system for monitoring the hard disk drives of the present disclosure.

FIG. 3 is a flowchart of an embodiment of a method for monitoring the hard disk drives of the present disclosure.

### DETAILED DESCRIPTION

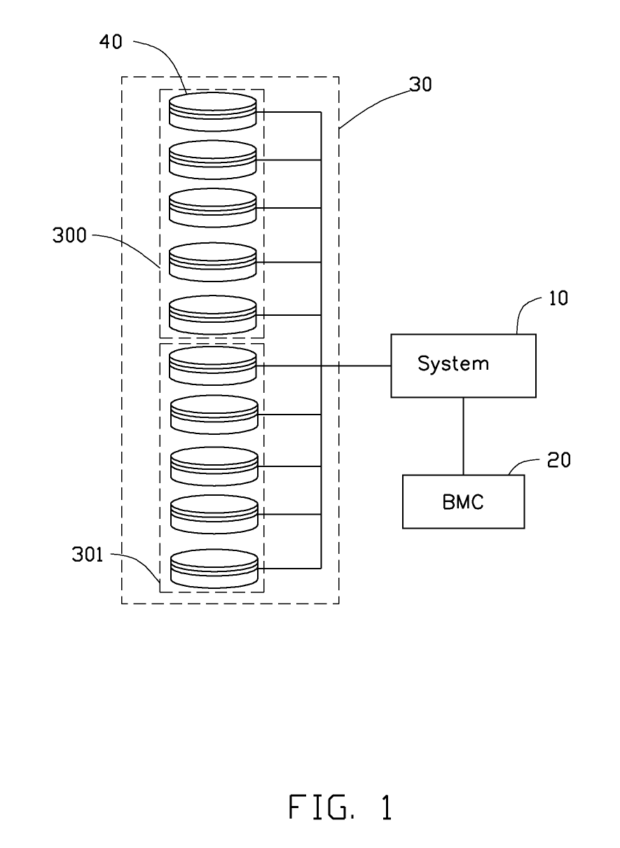

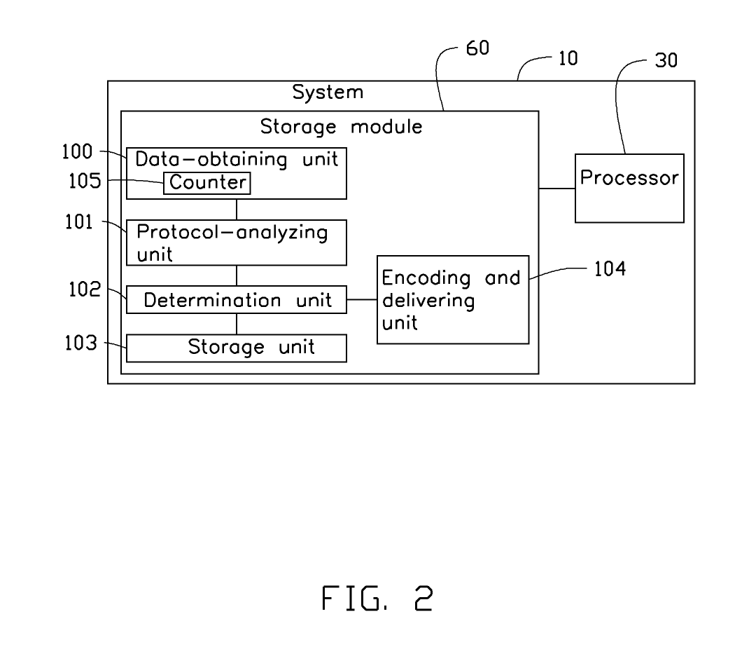

FIGS. 1 and 2 illustrate an embodiment of a system 10 for remotely monitoring a first group 300 of hard disk drives (HDDs) 40 and a second group 301 of the HDDs 40, in a server 30. Each of the first group 300 and the second group 301 includes five HDDs 40. The system 10 includes a processor 30 and a storage module 20. The storage module 20 includes a data-obtaining unit 100, a protocol-analyzing unit 101, a determination unit 102, a storage unit 103, and an encoding and delivering unit 104, which may include one or more computerized instructions executed by the processor 30.

In the embodiment, each HDD 40 is connected to a HDD connector. Each HDD 40 communicates with the data-obtaining unit 100 through a serial general purpose input output (SGPIO) bus. The data-obtaining unit 100 obtains a status message of each HDD 40 through the SGPIO bus.

Each status message includes three binary bits according to the SGPIO protocol. A first bit of the status message indicates the operating status of the HDD 40. For example, when the HDD 40 is operating, the first bit is “1”, and when the HDD 40 is not operating, the first bit is “0”. A second bit of the status message is definable by the user. In the embodiment, the second bit is defined to show the connection information of the HDD 40. For example, when the HDD 40 is not plugged into the corresponding HDD connector, the second bit is “1”, and when the HDD 40 is plugged into the corresponding HDD connector, the second bit of the message packet is “0”.

A third bit of the status message indicates the working status of the HDD 40. When the HDD 40 is working normally, the third bit is “0”, and when the HDD 40 is not working normally or fails, the third bit is “1”.

The data-obtaining unit 100 obtains the status messages of HDDs 40 of one group in a round-robin polling mode or in a scheduled mode and forms a message package for transmission to the protocol-analyzing unit 101. The data-obtaining unit 100 includes a counter 105. The counter 105 is increased by one after obtaining all the status messages of the group. In the embodiment, each message package includes five successive status messages.

The protocol-analyzing unit 101 decodes each message package according to the SGPIO protocol to intermediate codes and adds a flag behind each of the intermediate codes to form status codes. The status codes are then transferred to the determination unit 102. In the embodiment, if the intermediate code comprises the third bits of the five successive status messages of the group, the flag is “11”. If the intermediate code comprises the second bits of the five successive status messages of the group, the flag is“10”. If the intermediate code comprises the first bits of the five successive status messages of the group, the flag is “01”. Thus, each message package includes three status codes. Thus a status code of “0011011” would be derived from an intermediate code of “00110” comprised the third bits of the five successive status messages of the group.

When the protocol-analyzing unit 101 decodes the message package of the group, the current count of the counter 105 is transferred to the determination unit 102.

The storage unit 103 saves a plurality of warning message types, such as “working abnormally” and “working normally”.

Group numbers are transferred to the determination unit 102. The determination unit 102 obtains a current group number according to the group numbers and the current count of the counter 105. For example, the determination unit 102 subtracts an initial value of the counter 105 from the current count to obtain an intermediate value, and obtains a remainder between the intermediate value and the total group numbers. The current group number is the remainder increased by one. In the embodiment, the initial value of the counter 105 is zero. If the value of the counter 105 is ten and the total group numbers are two, then, the current group number is one. In other embodiments, the initial value of the counter 105 may not zero. For example, if the current count of the counter 105 is ten, the initial value of the counter 105 is two, and the total group numbers are two, then the current group number is one, that is ((10−2)%2)+1=1.

The determination unit 102 can retrieve a warning message by comparing the status code with the warning message types in the storage unit 103. For example, if a status code is “0010011”, the corresponding warning message is that the third HDD of the group is “working abnormally.” The warning message and the current group number are transferred to the encoding and delivering unit 104. The encoding and delivering unit 104 delivers the warning message and the current group number to the BMC 20, which is accessible by a remote client.

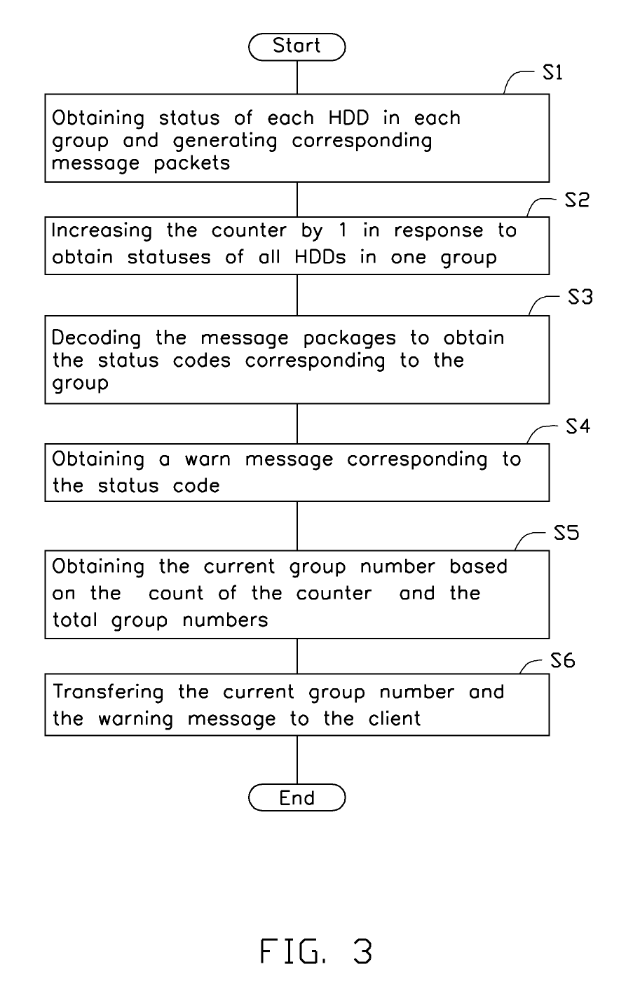

FIG. 3 illustrates a method for remotely monitoring a plurality of groups of hard disk drives (HDDs) 40 in a server 30. The method includes steps shown below.

Step S1, the data-obtaining unit 100 obtains a status message of each HDD 40 and forms a message package including all the status messages of the HDDs of one group.

Step S2, the counter 105 is increased by one after obtaining all the status messages of the group.

Step S3, the protocol-analyzing unit 101 decodes the message package to generate three status codes. Each status code comprises an intermediate code and a two-bit flag.

Step S4, the determination unit 102 retrieves a warning message by comparing the status code with all the warning message types saved in a storage unit 103.

Step S5, the determination unit 102 obtains the current group number based on the count of the counter 105 and the total number of groups.

Step S6, the encoding and delivering unit 104 transfers the current group number and the warning message to the client through a baseboard management controller 20.

While the disclosure has been described by way of example and in terms of preferred embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A system for monitoring a plurality of groups of hard disk drives (HDDs) in a server, the system comprising:
a processor; and
a storage module connected to the processor, and storing a plurality of computerized instructions executed by the processor, wherein the storage module comprises:
a data-obtaining unit configured to obtain a status message of each HDD, wherein the data-obtaining unit comprises a counter that is increased by one after obtaining all the status message of one group and forms a message package comprising all the status message of the group;
a protocol-analyzing unit configured to decode the message package and generate a plurality of status codes and obtain the count of the counter;
a storage unit storing a plurality of warning message types;
a determination unit obtaining a warning message by comparing the status code with the warning message types and obtaining a current group number based on the count of the counter and the total number of groups; and
an encoding and delivering unit transferring the warning message and the current group number.

2. The system of claim 1, wherein the data-obtaining unit obtains the status messages of the group in a round-robin polling mode or in a scheduled mode.

3. The system of claim 1, wherein the data-obtaining unit obtains the status message of each HDD through a serial general purpose input output (SGPIO) bus.

4. The system of claim 3, wherein each status message comprises three binary bits, the protocol-analyzing unit decodes the message package to three status codes, each status code comprises an intermediate code comprising corresponding bits of the message package and a flag.

5. The system of claim 1, wherein the determination unit subtracts an initial value of the counter from a current count of the counter to obtain an intermediate value, and obtains a remainder between the intermediate value and the total group numbers, the current group number is the remainder increased by one.

6. A method for monitoring a plurality of groups of hard disk drives (HDDs) in a server, the method comprising:
obtaining a status message of each HDD and forming a message package including all the status message of one group;
increasing a counter by one after obtaining all the status messages of the group;
decoding the message package to generate a plurality status codes;
retrieving a warning message corresponding to the status code;
obtaining a current group number based on the value of the counter and the total number of groups; and
transferring the current group number and the warning message.

7. The method of claim 6, wherein the status message of each HDD of the group is obtained in round-robin polling mode or in a scheduled mode.

8. The method of claim 6, wherein the step the status message of each HDD of the group is obtained through a serial general purpose input output (SGPIO) bus.

9. The method of claim 8, wherein each status code comprises an intermediate code composed of corresponding bits of the message package and a flag.

10. The method of claim 6, wherein the step “obtaining a current group number based on the value of the counter and the total group numbers” further comprises:
subtracting an initial value of the counter from a current count of the counter, to obtain an intermediate value;
obtaining a remainder between the intermediate value and the group numbers; and
increasing the remainder by one, to generate the current group number.
